(19) United States
(12) Patent Application Publication
(10) Pub. No.: US 2024/0077968 A1
(43) Pub. Date: Mar. 7, 2024

(54) Electronic Device Having Sensors Laminated to One or More Interior Surfaces of a Housing

(71) Applicant: Apple Inc., Cupertino, CA (US)

(72) Inventors: Zhiyuan Sun, Cupertino, CA (US); Wei Lin, Santa Clara, CA (US); Ying-da Wang, Taipei City (TW); Chun-Chih Chang, Taichung (TW); Nathan K. Gupta, San Francisco, CA (US); Travis N. Owens, Lakeway, TX (US); Karan S. Jain, Cupertino, CA (US); Supratik Datta, Sunnyvale, CA (US); Kyle J. Campiotti, San Jose, CA (US)

(21) Appl. No.: 18/240,100

(22) Filed: Aug. 30, 2023

Related U.S. Application Data
(60) Provisional application No. 63/404,132, filed on Sep. 6, 2022.

(51) Int. Cl. G06F 3/041; H04R 1/10

(52) U.S. Cl. CPC G06F 3/0414; H04R 1/1041

(57) ABSTRACT

An electronic device has sensors. More particularly, the electronic device is a small form factor electronic device such as earbuds, styluses, or electronic pencils, earphones, and so on. In some implementations, one or more touch sensors and one or more force sensors are coupled to a flexible circuit. In various implementations, the touch sensor and the force sensor are part of a single module controlled by a single controller. In a number of implementations, the flexible circuit is laminated to one or more portions of an interior surface of the electronic device.

### CROSS-REFERENCE TO RELATED APPLICATION(S)

This application is a nonprovisional and claims the benefit under 35 U.S.C. 119(e) of U.S. Provisional Patent Application No. 63/404,132, filed Sep. 6, 2022, the contents of which are incorporated herein by reference as if fully disclosed herein.

### FIELD

The described embodiments generally relate to electronic devices having sensors and, more particularly, to small form factor electronic devices such as earbuds, styluses, or electronic pencils.

### BACKGROUND

Earphones are often used to provide audio output to users of electronic devices without overly disturbing people around them. For example, headsets for personal electronic devices (such as computing devices, digital media players, music players, transistor radios, and so on) typically include a pair of earphones. These earphones are usually configured with ear cups that go over the user's ears or with ear pieces or speakers that insert into the user's ear canal in order to form an acoustic chamber with the user's ear. The earphones typically produce acoustic waves that are transmitted into that acoustic chamber through one or more acoustic ports. In this way, the user can hear the audio output without overly disturbing people in the environment around the user.

Many such earphones include no input devices. Instead, such earphones may be controlled using input devices incorporated into external electronic devices to which the earphones may be wired or wirelessly coupled.

Other earphones may include one or more input devices. For example, earphones may be configured with one or more buttons, dials, switches, sliders, and so on. Such input devices may be used to activate (e.g., provide input to) the earphone. Other electronic devices, such as styluses, may include one or more similar input devices.

### SUMMARY

The present disclosure relates to electronic devices having sensors and, more particularly, to small form factor electronic devices such as earbuds, styluses, or electronic pencils, earphones, and so on. In some implementations, one or more touch sensors and one or more force sensors are coupled to a flexible circuit. In various implementations, the touch sensor and the force sensor are part of a single module controlled by a single controller. In a number of implementations, the flexible circuit is laminated to one or more portions of an interior surface of the electronic device.

In various embodiments, an electronic device includes a housing that includes an input surface, a conductive object disposed within the housing, a flexible circuit positioned between the housing and the conductive object, a touch sensor electrode coupled to the flexible circuit facing the housing, a force sensor electrode coupled to the flexible circuit facing the conductive object, and at least one integrated circuit, electrically coupled to the touch sensor electrode and the force sensor electrode via the flexible circuit, that is operable to receive signals from the touch sensor electrode and the force sensor electrode.

In some examples, the electronic device is an earphone. In various implementations of such examples, the housing includes a speaker housing and a stem extending from the speaker housing, the stem defining the input surface, wherein the electronic device further includes a speaker positioned in the speaker housing.

In a number of examples, the electronic device further includes a deformable material positioned between the force sensor electrode and the conductive object operable to deform when a force is applied to the input surface. In various examples, the electronic device further includes a shield disposed between the touch sensor electrode and the force sensor electrode.

In various examples, the at least one integrated circuit is a system in a package and an analog front-end. In a number of examples, the conductive object is an antenna.

In some embodiments, an electronic device includes a housing that includes an input surface, a conductive object disposed within the housing, a flexible circuit laminated to the housing and positioned between the housing and the conductive object, a deformable material positioned between the flexible circuit and the conductive object operable to deform when a force is applied to the input surface, a touch sensor component coupled to the flexible circuit, a force sensor component coupled to the flexible circuit, and at least one integrated circuit that is operable to receive signals from the touch sensor component and the force sensor component.

In various examples, the flexible circuit is laminated to a flat portion of an interior wall of the housing. In some examples, the flexible circuit is laminated to a first portion of an interior wall of the housing and a second portion of the interior wall of the housing. In a number of implementations of such examples, the second portion of the interior wall of the housing is curved. In various implementations of such examples, the second portion of the interior wall of the housing is opposite the first portion of the interior wall of the housing.

In some examples, the force sensor component is a strain gauge. In various examples, the electronic device includes a serpentine structure that is both the touch sensor component and the force sensor component.

In a number of embodiments, an electronic device includes a housing that includes an input surface, a flexible circuit, a touch sensor electrode coupled to the flexible circuit facing the housing, a force sensor electrode coupled to the flexible circuit facing an interior of the housing, and at least one integrated circuit operable to receive signals from the touch sensor electrode and the force sensor electrode.

In some examples, at least one of the force sensor electrode or the touch sensor electrode includes multiple pixels. In various examples, the at least one integrated circuit is operable to use a first of the force sensor electrode and the touch sensor electrode as a shield while receiving a signal from a second of the force sensor electrode and the touch sensor electrode.

In a number of examples, the electronic device further includes a shield positioned between the force sensor electrode and the touch sensor electrode.

In various examples, the at least one integrated circuit is operable to receive signals from the touch sensor electrode and the force sensor electrode using at least one of time domain multiplexing or frequency domain multiplexing. In a number of examples, at least one of the touch sensor electrode or the force sensor electrode is at least partially embedded in the flexible circuit.

### BRIEF DESCRIPTION OF THE DRAWINGS

The disclosure will be readily understood by the following detailed description in conjunction with the accompanying drawings, wherein like reference numerals designate like structural elements.

FIG. 1A depicts a block diagram illustrating example functional relationships between example components that may be implemented in an electronic device.

FIG. 1B depicts an example implementation of the electronic device of FIG. 1A.

FIG. 1C depicts an example cross-sectional view of the electronic device of FIG. 1B, taken along line A-A of FIG. 1B.

FIG. 2 depicts a first alternative implementation of the electronic device of FIG. 1C that omits the dielectric material.

FIG. 3 depicts a second alternative implementation of the electronic device of FIG. 1C with two input surfaces.

FIG. 4 depicts a first example of a stack that may be used to implement a flexible circuit, such as the flexible circuits of FIGS. 1C, 2, and/or 3.

FIG. 5 depicts a second example of a stack that may be used to implement a flexible circuit, such as the flexible circuits of FIGS. 1C, 2, and/or 3.

FIG. 6 depicts a third example of a stack that may be used to implement a flexible circuit, such as the flexible circuits of FIGS. 1C, 2, and/or 3.

FIG. 7 depicts a fourth example of a stack that may be used to implement a flexible circuit, such as the flexible circuits of FIGS. 1C, 2, and/or 3.

FIG. 8 depicts a first alternative pixel and/or electrode configuration that may be used in both touch and force sensors, such as with the flexible circuits of FIGS. 1C, 2, and/or 3.

FIG. 9 depicts a second alternative pixel and/or electrode configuration that may be used in both touch and force sensors, such as with the flexible circuits of FIGS. 1C, 2, and/or 3.

FIG. 10 is a flow chart illustrating a method for determining input using one or more signals from one or more sensors. This method may be performed by using one or more of the components of FIGS. 1A-9.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and computer program products that embody various elements of the present disclosure. However, it should be understood that the described disclosure may be practiced in a variety of forms in addition to those described herein.

Earphones (and/or other electronic devices) that include mechanical input devices (such as buttons, dials, switches, sliders, and so on) disposed on, or accessible through, a housing surface may be challenging to operate as a user may not be able to see the mechanical input devices while the earphones are worn. Some earphones may attempt to solve this by using input mechanisms that detect one or more taps from a user. However, though a user may be able to activate (e.g., provide input to) the earphone more easily by tapping than by locating a button to press, tapping the earphone may conduct sound. This may be unpleasant to the user. This may also disrupt audio output produced by the earphone. Further, in implementations where the earphone includes one or more microphones, the tapping may be picked up by a microphone.

The present disclosure relates to electronic devices having sensors and, more particularly, to small form factor electronic devices such as earbuds, styluses, or electronic pencils, earphones, and so on. In some implementations, one or more touch sensors and one or more force sensors are coupled to a flexible circuit. In various implementations, the touch sensor and the force sensor are part of a single module controlled by a single controller. In a number of implementations, the flexible circuit is laminated to one or more portions of an interior surface of the electronic device.

An electronic device (e.g., an earbud, stylus, or electronic pencil) having a housing (e.g., a plastic housing) may include a flexible printed circuit having one or more sensors or sensor components attached thereto. In some embodiments, the sensors or sensor components may include a touch sensor (e.g., a capacitive touch sensor or other type of touch sensor) and at least part of a force sensor (e.g., at least one electrode of a capacitive force sensor, or part or all of another type of force sensor). In some embodiments, the touch sensor may be used to receive basic touch input, as well as swipe or gesture input, from a user. An adhesive may be applied to the flexible printed circuit, the sensors, or the sensor components—sometimes at positions that are aligned with the sensors or sensor components. The adhesive may be used to adhere the sensors or sensor components to one or more interior surfaces of the housing of the electronic device. Alternatively or additionally, an adhesive may be applied to the interior surface, and the sensors or sensor components may be adhered to the interior surface via the adhesive.

In some embodiments, the touch sensor or force sensor may include a single pixel. In some embodiments, the touch sensor or force sensor may include more than one pixel. In some embodiments, the touch sensor may include more than one pixel (e.g., three pixels), and the force sensor may include a single pixel. A multi-pixel touch sensor can be used to detect swipe or gesture inputs.

In some embodiments, capacitive touch and force sensor electrodes may be stacked (e.g., attached to opposite sides of a flexible printed circuit). Electrical conductors that are used to actively drive (e.g., modulate) or read (e.g., sense a capacitance of) a touch or force sensor pixel may be connected between each touch or force sensor pixel and one or more integrated circuit (IC) based devices (e.g., one or more system-in-package (SIP) devices). In some embodiments, a single IC or SIP may include touch and force sensor control or readout circuitry. In some embodiments, different ICs may be provided for touch versus force sensor control or readout circuitry.

In some embodiments, a first one or more adhesive areas may be used to attach stacked touch and force sensor electrodes to one region of an interior surface of a housing, and a second one or more adhesive areas may be used to attach one or more ICs that control or read the touch and force sensors to another region of the interior surface (or to another interior surface) of the housing. In some embodiments, a first adhesive area may be used to attach stacked touch and force sensor electrodes to a first region of an interior surface of a housing, and a second adhesive area may be used to attach a single SIP that controls and reads the touch and force sensors to a second region of an interior surface (e.g., the same or different interior surface) of the housing. In some embodiments, the flexible printed circuit may be bent to align the first adhesive area with the first region and align the second adhesive area with the second region.

In some embodiments, one or more touch sensor pixels (e.g., electrodes) may be attached to a first side of a flexible printed circuit, and one or more force sensor pixels (e.g., electrodes) may be attached to a second side of the flexible printed circuit. An adhesive may then be applied over the touch sensor pixels, and the flexible printed circuit and sensors may be attached to an interior surface of a housing with the touch sensor pixel(s) facing the interior surface, and with the force sensor pixel(s) separated from the interior surface by the touch sensor pixel(s) and at least a portion of the flexible printed circuit. In other embodiments, the force sensor pixel(s) may face the interior surface of the housing and the touch sensor pixel(s) may be separated from the interior surface by the force sensor pixel(s) and at least a portion of the flexible printed circuit.

In some embodiments, the flexible printed circuit may have a first portion to which the touch and force sensor electrodes are attached, and a second portion to which a connector, an array of solder pads, or other electrical conductors are attached. The first and second portions of the flexible printed circuit may be mechanically connected by a third portion (or neck) of the flexible printed circuit. The third portion may be bent to align the electrical conductors attached to the second portion with a system printed circuit board (or system flexible printed circuit) or other component. In some embodiments, the third portion may be bent and doubled back so that the third portion is positioned at least partly under the second portion or the first portion.

In some embodiments, the housing may be formed of ABS (acrylonitrile butadiene styrene) plastic. The touch and force sensors (and optional IC(s)) may be bonded (e.g., laminated) to flat or curved regions of the interior surface of the housing. In some embodiments, the adhesive may be a relatively hard (or hard) adhesive (e.g., a cured adhesive), instead of a typical soft pressure sensitive adhesive (PSA), such that the adhesive forms a structural bond and improves the mechanical coupling of the sensors to the housing. In some embodiments, the adhesive may be a UV (ultraviolet) (B stage) adhesive or a low temperature thermally curable adhesive.

In some embodiments, the above-mentioned adhesive types may be used to laminate a sensor, flexible printed circuit, IC or SIP, or other component to an interior surface of a housing without the presence of any air pockets or voids in the adhesive, thereby improving the structural bond of the component to the housing and improving the consistency of the structural bond.

In some embodiments, a capacitive sensor, strain sensor, or other type of sensor may be laminated to a curved interior surface of a housing using one of the above-mentioned adhesive types. The resultant structural bond may allow an electrode or resistor of the sensor, for example, to flex similarly to how an exterior surface of the housing flexes.

In some embodiments, an electronic device may include a housing having an interior, with the interior bounded by one or more interior surfaces. A first sensor may be attached to a first side of a substrate such as a flexible printed circuit. A second sensor may be attached to a second side of the substrate, opposite the first side, with the substrate extending between the first and second sensors. An adhesive, such as a UV (B stage) adhesive or a low temperature thermally curable adhesive, may adhere the first sensor to an interior surface of the housing, thereby attaching the substrate and the second sensor to the interior surface of the housing. In some embodiments, a control circuit including an IC or SIP may be attached to the substrate, and the adhesive may also be used to attach the control circuit to an interior surface of the housing. The first sensor and control circuit may be adhesively bonded to different portions of the same interior surface or to different interior surfaces. In some embodiments, the substrate may be bent or flexed between the first sensor and the control circuit. In some embodiments, a set of one or more electrical conductors may be routed from the first sensor, the second sensor, or the control circuit to another portion of the substrate, spaced apart from portions to which the first and second sensors and control circuit are attached. The substrate may be bent or flexed between the control circuit and portion of the substrate to which the electrical conductors are routed.

Directional terminology, such as “top”, “bottom”, “upper”, “lower”, “front”, “back”, “over”, “under”, “above”, “below”, “left”, or “right” may be used with reference to the orientation of some of the components in some of the figures described below. Because components in various embodiments can be positioned in a number of different orientations, directional terminology is used for purposes of illustration only and is usually not limiting. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

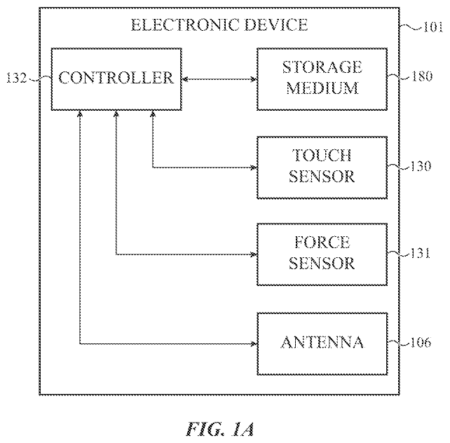

These and other embodiments are discussed below with reference to FIGS. 1-10. However, those skilled in the art will readily appreciate that the detailed description given herein with respect to these Figures is for explanatory purposes only and should not be construed as limiting.

FIG. 1A depicts a block diagram illustrating example functional relationships between example components that may be used to implement an electronic device 101. The electronic device 101 may include a controller 132 that is operative to interpret various touches to and/or forces exerted upon the electronic device 101 as input. For example, the electronic device 101 may be an earphone with one or more input surfaces defined on a housing. The controller 132 may use one or more touch sensors 130 and/or force sensors 131 to detect touches on the input surface, force applied to the input surface, and so on. For example, the electronic device 101 may include one or more mutual capacitance touch sensors, self-capacitance touch sensors, mutual capacitance force sensors, self-capacitance force sensors, strain gauges, optical sensors, pressure sensors, proximity sensors, switches, temperature sensors, dome switches, displacement sensors, and so on.

The electronic device 101 may also include an antenna 106, one or more non-transitory storage media 180 (which may take the form of, but is not limited to, a magnetic storage medium; optical storage medium; magneto-optical storage medium; read only memory; random access memory; erasable programmable memory; flash memory; and so on), and/or one or more other components. The controller 132 may execute instructions stored in the non-transitory storage medium 180 to perform various functions, such as using the touch sensor 130 to detect touch, using the force sensor 131 to detect applied force, using the antenna 106 to communicate with an associated device, and so on

FIG. 1B depicts an example implementation of the electronic device 101. As illustrated, in some implementations, the electronic device 101 may be an earphone. In this example, the electronic device 101 is a wireless earphone. However, it is understood that this is an example. In various implementations, the electronic device 101 may be any kind of electronic device, such as a mobile computing device, a stylus, and so on. Various configurations are possible and contemplated.

The electronic device 101 may include a housing including a speaker 102 and a stem 103. The stem 103 may define an input surface 104. A user may be able to touch, press, hold, squeeze, and/or otherwise interact with the input surface 104. This may allow the user to activate and/or otherwise provide touch, force, and/or other input to the electronic device 101.

The speaker 102 may define an acoustic chamber in cooperation with an ear of a user. In some implementations, the speaker 102 may also include a microphone acoustic port.

As described above with respect to FIG. 1A, the electronic device 101 may include a number of different sensors for detecting touch on and/or force applied to the input surface 104.

For example, the electronic device 101 may detect a non-binary amount of force applied to the input surface 104. The amount of the force detected may be non-binary because the electronic device 101 is operative to determine an amount of the force that is applied within a range of force amounts rather than only a binary detection of whether or not force is applied. The electronic device 101 may interpret the applied force as a first input if the amount of the force is less than a force threshold. However, the electronic device 101 may interpret the force as a second input if the amount of the force at least meets the force threshold.

In some examples, the electronic device 101 may determine other information about touch or applied force. For example, the electronic device 101 (or controller or other processing unit thereof) may also determine an amount of time that a force is applied. The electronic device 101 may interpret force that is applied for an extended period of time as a different input than a force that is applied and then immediately released. In such an example, the electronic device 101 may interpret an applied force as multiple different kinds of input depending on the amount of the force that is applied, the amount of time that the force is applied, the direction that force is applied, and/or other aspects of the applied force.

In some examples, the electronic device 101 may include both a force sensor and a touch sensor. As such, the electronic device 101 may be operative to determine both touch and force to the input surface 104.

In various examples, the electronic device 101 may use the force sensor to determine a non-binary amount of force applied only upon detection of a touch. This may prevent false readings, as objects other than a user could exert force on the housing. This may also reduce power consumption as compared to operating the force sensor more often or continuously. In examples where the electronic device 101 is powered by one or more batteries and/or is otherwise portable, this reduced power consumption may conserve the life of batteries and/or other components.

In other examples, the electronic device 101 may use the force sensor and a touch sensor to determine the amount of the force. For example, the electronic device 101 may use the force sensor regardless of whether or not touch is detected, but may only use signals from the force sensor when a touch is detected.

FIG. 1C depicts an example cross-sectional view of the electronic device 101 of FIG. 1B, taken along line A-A of FIG. 1B. An assembly disposed within the stem 103 may include a flexible circuit 110, a controller 105 (which may be a SIP, such as a SIP with an analog front chipset, and/or other integrated circuit and/or device), a system interconnect 115, a dielectric material 113 (such as foam, gel, silicone, and/or another material), and a conductive object 116 (such as an antenna).

The flexible circuit 110 may be laminated to one or more portions of the interior surface (such as one or more flat portions, curved portions, and so on) of the stem 103 via adhesive 111, such as a first portion 112a and a second portion 112b. This lamination may enable more accurate positioning of the flexible circuit 110 in tight spaces within the stem 103 during assembly, which may enable more accurate signals from one or more sensors that may be coupled to and/or partially and/or fully included in the flexible circuit 110.

The flexible circuit 110 may form one or more touch sensors and/or force sensors. As such, the input surface 104 may be a touch input surface and/or a force input surface. The touch sensor may be formed using one or more touch sensor pixels and/or electrodes that may be formed on the flexible circuit 110 and/or partially and/or fully embedded within the flexible circuit 110. In some examples, such touch sensor pixels and/or electrodes may be positioned on one side of the flexible circuit 110 and/or otherwise facing the interior surface of the stem 103. The force sensor may be formed using one or more force sensor pixels and/or electrodes that may be formed on the flexible circuit 110 and/or partially and/or fully embedded within the flexible circuit 110. In some examples, such force sensor pixels and/or electrodes may be positioned on an opposite side of the flexible circuit 110 from the touch sensor pixels and/or electrodes and/or otherwise facing the dielectric material 113 and/or the conductive object 116.

In various implementations, force applied to the force input surface may be determined or estimated upon detection of a touch to the touch input surface. This may reduce power consumption over implementations where force detection is constantly or more frequently performed.

In other examples, the force sensor and touch sensor may be used to determine the amount of the force. For example, the force sensor may be operated regardless of whether or not touch is detected, but signals from the force sensor may only be used when the touch sensor detects a touch. This may ensure that a user intentionally applied the force.

The flexible circuit 110 may include multiple circuitry sections that are connected to each other. The flexible circuit 110 may be able to flex, bend, or otherwise deform when a force is applied to the housing, such as the input surface 104. This may reduce a gap filled by the dielectric material 113, deforming the dielectric material 113 so that one or more force sensor pixels and/or electrodes move closer to the conductive object 116, changing a capacitance between the one or more force sensor pixels and/or electrodes move closer to the conductive object 116. The flexible circuit 110 may also be able to flex, bend, or otherwise deform to allow when the force is no longer applied.

However, it is understood that this is an example. In other implementations, the configuration of the electronic device 101 may allow one or more touch sensors and/or the force sensors to be disposed within the stem 103 without being laminated and/or otherwise affixed to the stem 103.

The controller 105 may be electrically and/or otherwise communicably coupled to various portions of the flexible circuit 110. The controller 105 may receive and/or evaluate touch data and/or other signals from one or more touch sensors, receive and/or evaluate force data and/or other signals from one or more force sensors, determine one or more touches using the touch data, determine a non-binary amount of applied force using the force data (and/or other information about the force, such as a duration that the force is applied), and so on. The controller 105 may be connected to a non-transitory storage medium that may store instructions executable by the controller 105.

Connection of a single controller 105 to both touch and force sensors using a single flexible circuit 110 may provide a number of efficiencies over implementations that use separate sensor/controller modules. For example, this implementation may provide space savings (such as by eliminating redundant components), power savings (such as by using a single controller 105 instead of two), reduce parasitic capacitances and coexistence aggression interference, reduce communication latency, reduce redundant circuitry and/or other components, improve communication speed, and so on. By way of illustration, the single controller 105 reading out signal data from both touch and force sensors may be able to interpret more complex inputs involving both touch and force that separate modules could not perform due to communication delays between the separate modules attempting to coordinate detected touch and force signals.

In order to connect a single controller 105 to multiple sensors, the sensing modality, read out chip, and dynamic range may need to be compatible. In other words, both sensors may need to be capacitive, strain, ultrasound, and so on. Capacitive touch and force sensing may be compatible regarding the sensing modality, read out chip, and dynamic range such that a single controller 105 can be connected to sensors for both. When both sensors use the same readout for both touch and force, the same and/or similar transmitters, receivers, chipsets, and so on may be used.

Although capacitive force and touch sensing is described above, other sensing modalities are possible and contemplated. These include piezoelectric (ultrasound, surface acoustic wave and passive elastic wave sensing, and so on), resistive strain gauge and resistive touch array, inductive touch and Lorentz force or magnetostrictive force sensing, piezoresistive touch/force sensing, optical touch and force sensing, combined resistive (strain for force) and capacitive (for touch) measurement for complex impedance with IQ demodulation, and so on.

Although the above illustrates and discusses the use of the controller 105, it is understood that this is an example. In other implementations, the touch and/or force sensors may be instead controlled by a system SIP and/or other controller of the electronic device 101 itself. Various configurations are possible and contemplated without departing from the scope of the present disclosure. Omission of the controller 105 may provide the benefit of tighter integration but may involve longer analog trace routing, coexistence aggression, and so on.

In various implementations, the controller 105 may only use the force sensor to detect a force applied to the stem 103 or other portion of the housing (such as the input surface 104) when the touch sensor detects a touch on the stem 103 or other portion of the housing. In some examples, the touch is on a first area of the housing and the force is applied to a second area of the housing. In a number of examples, the controller 105 is operative to interpret the force as multiple different kinds of input.

Although the above illustrates and describes inputs as touches on and/or force applied to the input surface 104, it is understood that this is an example. In various implementations, the electronic device 101 may be operable to detect touches on and/or force applied to other portions of the housing without departing from the scope of the present disclosure.

For example, the stem 103 may move when force is applied to areas orthogonal to the input surface 104. This may cause the gap to increase instead of decrease. Regardless, this may change the capacitance between force sensor pixels and/or electrodes and the conductive object 116. The non-binary amount of this force may thus be determined using the force data represented by the change in the mutual capacitance.

In some implementations, this change may be opposite the change in the mutual capacitance resulting from force exerted on the input surface 104. As such, the location that the force is exerted may be determined based on the change in the mutual capacitance. Various configurations are possible and contemplated without departing from the scope of the present disclosure.

Although the above is illustrated and described in the context of a gap that may reduce when a force is applied to the input surface 104 and increase when the force is no longer applied to the input surface 104, it is understood that this is an example. In other examples, a force sensor may be configured such that a gap increases when a force is applied to the input surface 104 and reduce when the force is no longer applied to the input surface 104. Various configurations are possible and contemplated without departing from the scope of the present disclosure.

Although the force sensor is described above as a mutual capacitive sensor, it is understood that this is an example. In other implementations, the force sensor may be a self-capacitive sensor, a piezoelectric sensor, a strain gauge, and so on. Various configurations are possible and contemplated without departing from the scope of the present disclosure.

The flexible circuit 110 may be a flexible printed circuit board (e.g., a “flex”). In some implementations, the flexible circuit 110 may be formed of conductive materials such as copper, silver, gold, or other metallic traces formed on a dielectric, such as polyimide or polyester.

The touch sensor may include one or more touch pixels and/or electrodes. For example, the touch sensor may include a touch drive pixel and/or electrode and a touch sense pixel and/or electrode. A touch on the touch input surface may be determined using a change in mutual capacitance of the touch drive pixel and/or electrode and the touch sense pixel and/or electrode. By way of another example, the touch sensor may include a single touch pixel and/or electrode and a touch to the input surface 104 may be determined using a change in the self-capacitance of the single touch pixel and/or electrode.

The force sensor may include a first force pixel and/or electrode and a second force pixel and/or electrode. For example, in some implementations, the first force pixel and/or electrode may be a force drive pixel and/or electrode and the second force pixel and/or electrode may be a force sense pixel and/or electrode. In other implementations, these may be reversed.

The touch and/or force sensors may need to be shielded from the environment and possibly from each other in order to operate precisely and not be adversely affected by interference, such as from coexistence aggressors. Shielding options in a combined module may include a solid copper layer between the two sensors and/or another shield, time domain multiplexing, frequency domain multiplexing (touch and force may be scanned at the same time where touch is demodulated at one frequency and force at another), and so on. Time domain multiplexing and/or frequency domain multiplexing may be more easily performed with a single controller 105 as there may be no need for an overhead clock and/or communication to synchronize. Shielding is discussed in more detail below.

Although the flexible circuit 110 is illustrated and described above, it is understood that this is an example. In various examples, touch and/or force sensors may be implemented on a printed circuit board, flexible printed circuit, other polymer substrate (such as polyethylene terephthalate, cyclic olefin polymer, and so on), or the like. The touch and force sensors may reside on the same substrate and/or multiple substrates that are laminated, connected using electrical interconnects (zero insertion force, board to board, anisotropic conductive film, or the like), and so on.

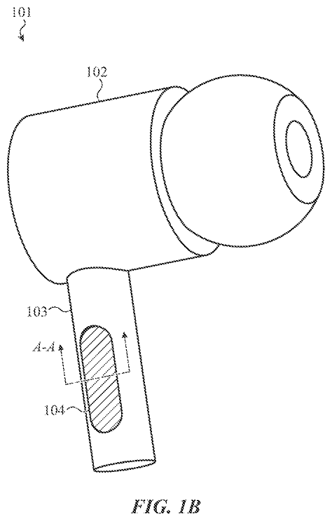

FIG. 2 depicts a first alternative implementation of the electronic device 101 of FIG. 1C that omits the dielectric material. The electronic device 201 may include an assembly disposed within a stem 203 that may include a flexible circuit 210 laminated to a first portion 212a of the interior surface of the stem 203 and a second portion 212b of the interior surface of the stem 203 using adhesive 211, a controller 205 (which may be a SIP, such as a SIP with an analog front chipset, and/or other integrated circuit and/or device), a system interconnect 215, a gap 213, and a conductive object 216 (such as an antenna).

Omission of the dielectric material 113 of FIG. 1C may reduce cost, eliminate components, and so on. However, use of the dielectric material 113 of FIG. 1C may improve sensor operation by enabling more precise control of capacitance between portions of the sensor by tuning the dielectric of the dielectric material. Various configurations are possible and contemplated without departing from the scope of the present disclosure.

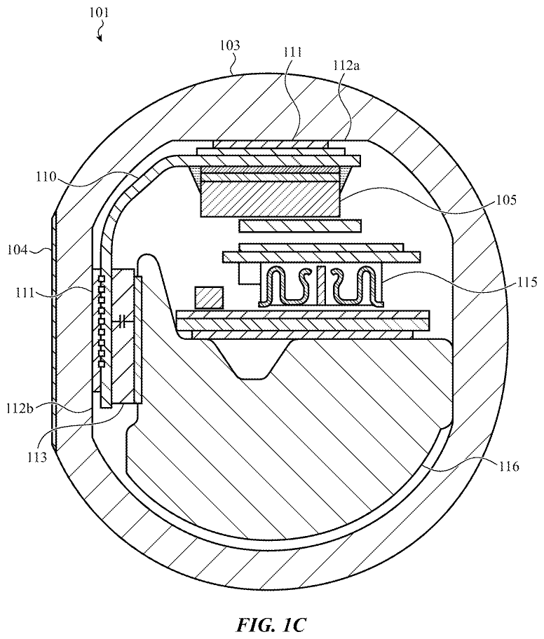

FIG. 3 depicts a second alternative implementation of the electronic device 101 of FIG. 1C with two input surfaces 304a and 304b. The electronic device 301 may include an assembly disposed within a stem 303 that may include a flexible circuit 310 coupled to a first portion of the interior surface of the stem 303 and a second portion of the interior surface of the stem 303 (such as by using adhesive, biasing mechanisms such as one or more springs, and so on), a controller (which may be a SIP, such as a SIP with an analog front chipset, and/or other integrated circuit and/or device), a system interconnect 315, and a conductive object 316 (such as an antenna).

In some examples, force and/or touch sensor components may be coupled to the flexible circuit 310 to enable force and/or touch detection at both of the input surfaces 304a, 304b. In other examples, force and/or touch sensor components may be coupled to the flexible circuit 310 to enable force detection at one of the input surfaces 304a, 304b and touch detection at the other. Various configurations are possible and contemplated without departing from the scope of the present disclosure.

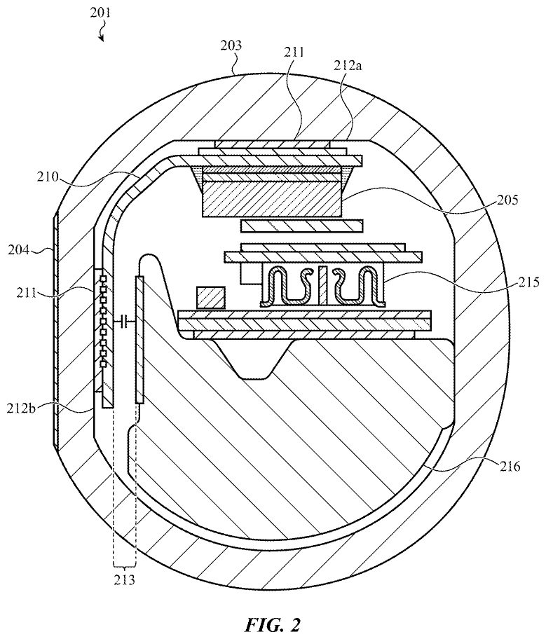

FIG. 4 depicts a first example of a stack that may be used to implement a flexible circuit, such as the flexible circuits of FIGS. 1C, 2, and/or 3. The stack may include a force pixel and/or electrode 421 (which may be formed of conductive material such as copper, silver, gold, other metallic traces, and so on) and a touch pixel and/or electrode 424 (which may be formed of conductive material such as copper, silver, gold, other metallic traces, and so on) separated by a shield 423 (which may be formed of conductive material such as copper, silver, gold, other metallic traces, and so on) and one or more layers of dielectric material 422, such as polyimide or polyester.

In some examples, the force pixel and/or electrode 421 may be scanned at the same time and/or sequentially as the touch pixel and/or electrode 424 due to the shield 423, which may shield both the force pixel and/or electrode 421 and the touch pixel and/or electrode 424. The shield 423 may be configured to be ground, may be a driven (alternating current) shield, and so on. Use of a single shield 423 may be enabled by the force pixel and/or electrode 421 and the touch pixel and/or electrode 424 being controlled by a single controller. Implementations without an integrated module may require separate shields for each of the force pixel and/or electrode 421 and the touch pixel and/or electrode 424.

In various implementations, the force pixel and/or electrode 421 and/or the touch pixel and/or electrode 424, and/or the shield 423 may be controlled differently at different times, such as using time domain multiplexing, frequency domain multiplexing, and so on. For example, during a force scan, the force pixel and/or electrode 421 may be used as a force pixel while the touch pixel and/or electrode 424 is used as a shield, floated, or configured to ground and the shield 423 is used as a shield. By way of another example, during a touch scan, the touch pixel and/or electrode 424 may be used as a touch pixel while the force pixel and/or electrode 421 is used as a shield, floated, or configured to ground and the shield 423 is used as a shield. The shield 423 may be time independent as the shield 423 is used as a shield during both force scan and touch scan.

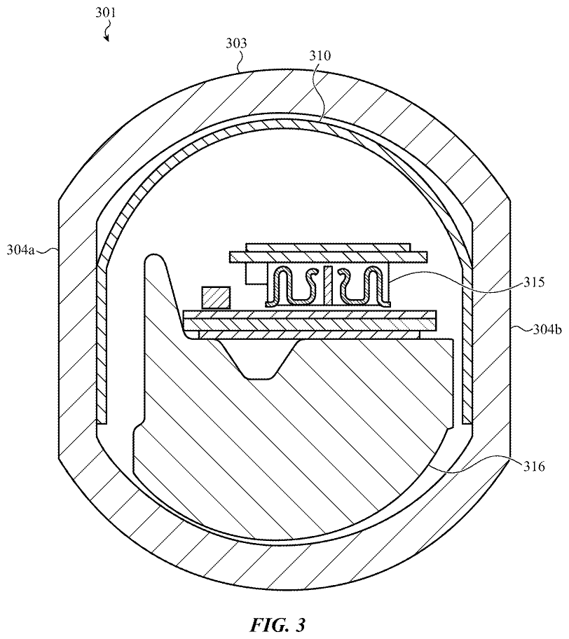

FIG. 5 depicts a second example of a stack that may be used to implement a flexible circuit, such as the flexible circuits of FIGS. 1C, 2, and/or 3. As contrasted with the example shown in FIG. 4, this example includes two force pixels and/or electrodes 521a, 521b and three touch pixels and/or electrodes 524a, 524b, 524c separated by a shield 523 and dielectric material 522. The various force pixels and/or electrodes 521a, 521b, touch pixels and/or electrodes 524a, 524b, 524c, and shield 523 may be controlled differently at different times similar to the operations described above with respect to FIG. 4.

Although FIG. 5 illustrates two force pixels and/or electrodes 521a, 521b and three touch pixels and/or electrodes 524a, 524b, 524c, it is understood that this is an example. In various implementations, any number of pixels and/or electrodes may be used without departing from the scope of the present disclosure.

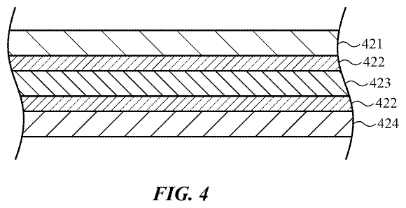

FIG. 6 depicts a third example of a stack that may be used to implement a flexible circuit, such as the flexible circuits of FIGS. 1C, 2, and/or 3. This stack may include a force pixel and/or electrode 621 and a touch pixel and/or electrode 624 separated by one or more layers of dielectric material 622. The force pixel and/or electrode 621 and the touch pixel and/or electrode 624 may be controlled differently at different times similar to the operations described above with respect to FIG. 4. Techniques such as time domain multiplexing and/or frequency domain multiplexing may be used so that the shield 423 of FIG. 4 may be omitted. For example, the force pixel and/or electrode 621 may be used as a shield during touch scans while the touch pixel and/or electrode 624 is scanned. Similarly, the touch pixel and/or electrode 624 may be used as a shield during force scans while the force pixel and/or electrode 621 is scanned. Various configurations are possible and contemplated without departing from the scope of the present disclosure.

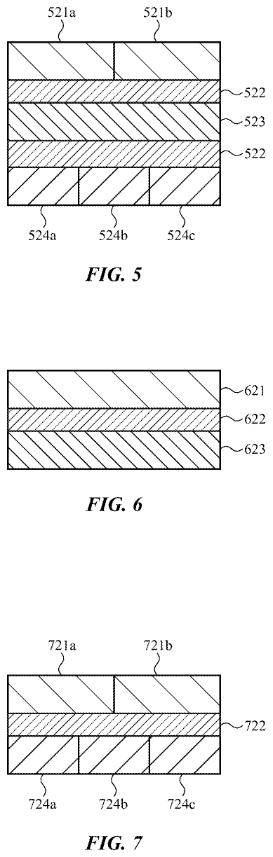

FIG. 7 depicts a fourth example of a stack that may be used to implement a flexible circuit, such as the flexible circuits of FIGS. 1C, 2, and/or 3. Similar to FIG. 5, this example includes two force pixels and/or electrodes 721a, 721b and three touch pixels and/or electrodes 724a, 724b, 724c separated by dielectric material 722. Similar to FIG. 6, the shield 523 of FIG. 5 is omitted.

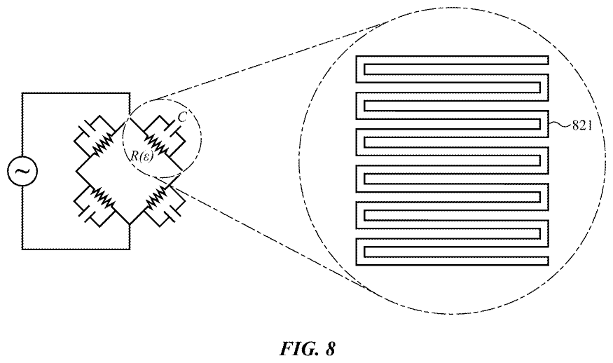

FIG. 8 depicts a first alternative pixel and/or electrode configuration 821 that may be used in both touch and force sensors, such as with the flexible circuits of FIGS. 1C, 2, and/or 3. A controller may demodulate phases of signals from the pixel and/or electrode such that one is representative of a resistive signal and the other is representative of a capacitance signal. The capacitance signal may be used to detect touch as touch may result in a capacitance change. Similarly, the resistive signal may be used to detect force as force may deform the pixel and/or electrode configuration 821, resulting in a resistive change.

As shown, the pixel and/or electrode configuration 821 is a single pixel and/or electrode with a serpentine configuration. However, it is understood that this is an example and that other configurations are possible and contemplated without departing from the scope of the present disclosure.

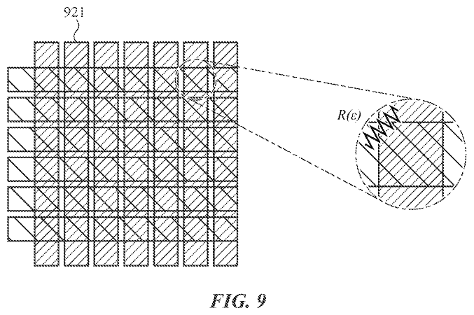

By way of illustration, FIG. 9 depicts a second alternative pixel and/or electrode configuration 921 that may be used in both touch and force sensors, such as with the flexible circuits of FIGS. 1C, 2, and/or 3. By way of contrast with the pixel and/or electrode configuration 821, the pixel and/or electrode configuration 921 includes rows and columns of pixels and/or electrodes with strain gauges, such as high resistance strain gauges, at node intersections between rows and columns. In some implementations, the rows may be used as drive and the columns may be used as sense. However, it is understood that this is an example. In other implementations, these may be reversed. Various configurations are possible and contemplated without departing from the scope of the present disclosure.

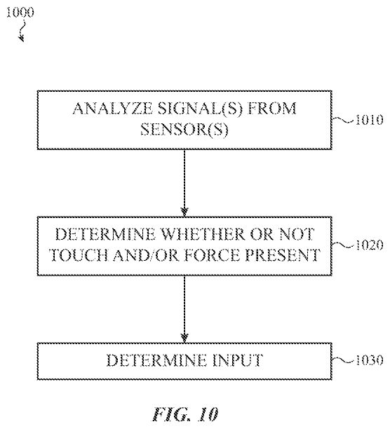

FIG. 10 is a flow chart illustrating a method 1000 for determining input using one or more signals from one or more sensors. This method 1000 may be performed by using one or more of the components of FIGS. 1A-9.

At operation 1010, an electronic device may analyze one or more signals from one or more sensors. For example, the electronic device may analyze a first signal from a touch sensor and a second signal from a touch sensor.

At operation 1020, the electronic device may determine whether or not touch and/or force is present. For example, the electronic device may use a first signal from a touch sensor and a second signal from a force sensor to determine that no touch or force is present, touch is present but not force, force is present but not touch, both touch and force are present, and so on.

At operation 1030, the electronic device may determine an input. For example, the electronic device may determine an input based on whether or not touch and/or force was determined to be present.

Although the example method 1000 is illustrated and described as including particular operations performed in a particular order, it is understood that this is an example. In various implementations, various orders of the same, similar, and/or different operations may be performed without departing from the scope of the present disclosure.

For example, operation 1030 is illustrated and described as determining an input. However, it is understood that this is an example. In various implementations, the electronic device may determine that an input has not been received. Various configurations are possible and contemplated without departing from the scope of the present disclosure.

In various implementations, an electronic device may include a housing that includes an input surface, a conductive object disposed within the housing, a flexible circuit positioned between the housing and the conductive object, a touch sensor electrode coupled to the flexible circuit facing the housing, a force sensor electrode coupled to the flexible circuit facing the conductive object, and at least one integrated circuit, electrically coupled to the touch sensor electrode and the force sensor electrode via the flexible circuit, that is operable to receive signals from the touch sensor electrode and the force sensor electrode.

In some examples, the electronic device may be an earphone. In various such examples, the housing may include a speaker housing and a stem extending from the speaker housing, the stem defining the input surface, wherein the electronic device further includes a speaker positioned in the speaker housing.

In a number of examples, the electronic device further may include a deformable material positioned between the force sensor electrode and the conductive object operable to deform when a force is applied to the input surface. In various examples, the electronic device may further include a shield disposed between the touch sensor electrode and the force sensor electrode.

In various examples, the at least one integrated circuit may be a system in a package and an analog front-end. In a number of examples, the conductive object may be an antenna.

In some implementations, an electronic device may include a housing that includes an input surface, a conductive object disposed within the housing, a flexible circuit laminated to the housing and positioned between the housing and the conductive object, a deformable material positioned between the flexible circuit and the conductive object operable to deform when a force is applied to the input surface, a touch sensor component coupled to the flexible circuit, a force sensor component coupled to the flexible circuit, and at least one integrated circuit that is operable to receive signals from the touch sensor component and the force sensor component.

In various examples, the flexible circuit may be laminated to a flat portion of an interior wall of the housing. In some examples, the flexible circuit may be laminated to a first portion of an interior wall of the housing and a second portion of the interior wall of the housing. In a number of such examples, the second portion of the interior wall of the housing may be curved. In various such examples, the second portion of the interior wall of the housing may be opposite the first portion of the interior wall of the housing.

In some examples, the force sensor component may be a strain gauge. In various examples, the electronic device may include a serpentine structure that is both the touch sensor component and the force sensor component.

In a number of implementations, an electronic device may include a housing that includes an input surface, a flexible circuit, a touch sensor electrode coupled to the flexible circuit facing the housing, a force sensor electrode coupled to the flexible circuit facing an interior of the housing, and at least one integrated circuit operable to receive signals from the touch sensor electrode and the force sensor electrode.

In some examples, at least one of the force sensor electrode or the touch sensor electrode may include multiple pixels. In various examples, the at least one integrated circuit may be operable to use a first of the force sensor electrode and the touch sensor electrode as a shield while receiving a signal from a second of the force sensor electrode and the touch sensor electrode.

In a number of examples, the electronic device may further include a shield positioned between the force sensor electrode and the touch sensor electrode.

In various examples, the at least one integrated circuit may be operable to receive signals from the touch sensor electrode and the force sensor electrode using at least one of time domain multiplexing or frequency domain multiplexing. In a number of examples, at least one of the touch sensor electrode or the force sensor electrode may be at least partially embedded in the flexible circuit.

As described above and illustrated in the accompanying figures, the present disclosure relates to electronic devices having sensors and, more particularly, to small form factor electronic devices such as earbuds, styluses, or electronic pencils, earphones, and so on. In some implementations, one or more touch sensors and one or more force sensors are coupled to a flexible circuit. In various implementations, the touch sensor and the force sensor are part of a single module controlled by a single controller. In a number of implementations, the flexible circuit is laminated to one or more portions of an interior surface of the electronic device.

Although the above illustrates and describes a number of embodiments, it is understood that these are examples. In various implementations, various techniques of individual embodiments may be combined without departing from the scope of the present disclosure.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An electronic device, comprising:
a housing that includes an input surface;
a conductive object disposed within the housing;
a flexible circuit positioned between the housing and the conductive object;
a touch sensor electrode coupled to the flexible circuit facing the housing;
a force sensor electrode coupled to the flexible circuit facing the conductive object; and
at least one integrated circuit, electrically coupled to the touch sensor electrode and the force sensor electrode via the flexible circuit, that is operable to receive signals from the touch sensor electrode and the force sensor electrode.

2. The electronic device of claim 1, wherein the electronic device comprises an earphone.

3. The electronic device of claim 2, wherein the housing includes:
a speaker housing; and
a stem extending from the speaker housing, the stem defining the input surface; wherein the electronic device further comprises a speaker positioned in the speaker housing.

4. The electronic device of claim 1, further comprising a deformable material positioned between the force sensor electrode and the conductive object operable to deform when a force is applied to the input surface.

5. The electronic device of claim 1, further comprising a shield disposed between the touch sensor electrode and the force sensor electrode.

6. The electronic device of claim 1, wherein the at least one integrated circuit comprises a system in a package and an analog front-end.

7. The electronic device of claim 1, wherein the conductive object comprises an antenna.

8. An electronic device, comprising:
a housing that includes an input surface;
a conductive object disposed within the housing;
a flexible circuit laminated to the housing and positioned between the housing and the conductive object;
a deformable material positioned between the flexible circuit and the conductive object operable to deform when a force is applied to the input surface;
a touch sensor component coupled to the flexible circuit;
a force sensor component coupled to the flexible circuit; and
at least one integrated circuit that is operable to receive signals from the touch sensor component and the force sensor component.

9. The electronic device of claim 8, wherein the flexible circuit is laminated to a flat portion of an interior wall of the housing.

10. The electronic device of claim 8, wherein the flexible circuit is laminated to a first portion of an interior wall of the housing and a second portion of the interior wall of the housing.

11. The electronic device of claim 10, wherein the second portion of the interior wall of the housing is curved.

12. The electronic device of claim 10, wherein the second portion of the interior wall of the housing is opposite the first portion of the interior wall of the housing.

13. The electronic device of claim 8, wherein the force sensor component comprises a strain gauge.

14. The electronic device of claim 8, further comprising a serpentine structure that comprises both the touch sensor component and the force sensor component.

15. An electronic device, comprising:
a housing that includes an input surface;
a flexible circuit;
a touch sensor electrode coupled to the flexible circuit facing the housing;
a force sensor electrode coupled to the flexible circuit facing an interior of the housing; and
at least one integrated circuit operable to receive signals from the touch sensor electrode and the force sensor electrode.

16. The electronic device of claim 15, wherein at least one of the force sensor electrode or the touch sensor electrode comprises multiple pixels.

17. The electronic device of claim 15, wherein the at least one integrated circuit is operable to use a first of the force sensor electrode and the touch sensor electrode as a shield while receiving a signal from a second of the force sensor electrode and the touch sensor electrode.

18. The electronic device of claim 15, further comprising a shield positioned between the force sensor electrode and the touch sensor electrode.

19. The electronic device of claim 15, wherein the at least one integrated circuit is operable to receive signals from the touch sensor electrode and the force sensor electrode using at least one of time domain multiplexing or frequency domain multiplexing.

20. The electronic device of claim 15, wherein at least one of the touch sensor electrode or the force sensor electrode is at least partially embedded in the flexible circuit.
